(19) United States
(12) Patent Application Publication
(10) Pub. No.: US 2023/0148399 A1
(43) Pub. Date: May 11, 2023

(54) Storage Body, Method of Manufacturing Storage Body, Garment, and Method of Attaching Wireless Charger

(71) Applicant: HOBONICHI CO., LTD., Tokyo (JP)

(72) Inventor: Shigesato Itoi, Tokyo (JP)

(21) Appl. No.: 17/911,842

(22) PCT Filed: Apr. 7, 2021
(86) PCT No.: PCT/JP2021/014704

§ 371 Date: Sep. 15, 2022

(30) Foreign Application Priority Data
Apr. 8, 2020 (JP) 2020-069840

(51) Int. Cl. A45C 11/00; H02J 50/10; H02J 7/00; A45C 15/00

(52) U.S. Cl. CPC A45C 11/00; H02J 50/10; H02J 7/0044; A45C 15/00; H04M 1/725

(57) ABSTRACT

An example storage body includes a first storage chamber in which a wireless charger is stored, a second storage chamber which is adjacent to the first storage chamber and in which a portable terminal to be charged by the wireless charger is to be stored, and an attachment/detachment tool that attaches and detaches the first storage chamber and the second storage chamber to and from an object. Preferably, the storage body further includes a guide that is disposed in the second storage chamber and positions the portable terminal at a power receiving position where the portable terminal is capable of receiving power to be supplied from the wireless charger.

This application is the national phase under 35 U.S.C. § 371 of PCT International Application No. PCT/JP2021/014704 which has International filing date of Apr. 7, 2021 and designated the United States of America.

### FIELD

The technology herein relates to a storage body in which a portable terminal is to be stored, a method of manufacturing the storage body, a garment, and a method of attaching a wireless charger.

### BACKGROUND AND SUMMARY

In the related art, a carry case in which a power transmission coil and a capacitor are disposed has been proposed. A placement surface on which a smartphone is to be placed is formed on an outer surface of the carry case at a position corresponding to the power transmission coil.

A user can place a smartphone on the placement surface to charge the smartphone.

However, the carry case is large and it is difficult to always carry the carry case. Further, since the use of the carry case is based on the assumption that a smartphone is placed on the placement surface, there is a concern that the smartphone will fall in a case where the carry case is moved.

The present disclosure has been made in consideration of such circumstances, and an object of the present disclosure is to provide a storage body for a portable terminal that can charge a portable terminal, can be carried by a user without a burden, and can charge the portable terminal even during movement.

A storage body according to an embodiment of the present disclosure includes a first storage chamber in which a wireless charger is stored, a second storage chamber which is adjacent to the first storage chamber and in which a portable terminal to be charged by the wireless charger is to be stored, and an attachment/detachment tool that attaches the first storage chamber and the second storage chamber to an object and detaches the first storage chamber and the second storage chamber to and from the object.

In the embodiment of the present disclosure, in a case where the portable terminal is stored in the second storage chamber, the portable terminal is charged by the wireless charger stored in the first storage chamber. Further, a user can mount the storage body on an object to be used by the user, for example, a bag or a garment by using the attachment/detachment tool.

The storage body according to the embodiment of the present disclosure further includes a guide that is disposed in the second storage chamber and positions the portable terminal at a power receiving position where the portable terminal is capable of receiving power to be supplied from the wireless charger.

In the embodiment of the present disclosure, the portable terminal is positioned at the power receiving position by the guide and is charged.

In the storage body according to the embodiment of the present disclosure, the second storage chamber is formed by a member having stretchability.

In the embodiment of the present disclosure, in a case where the portable terminal is stored in the second storage chamber, the second storage chamber extends and contracts to correspond to the dimensions of the portable terminal.

Accordingly, a plurality of types of portable terminals having different specifications can be stored.

In the storage body according to the embodiment of the present disclosure, the attachment/detachment tool includes a belt, a string, a magnet, a hook-and-loop fastener, a button, or a clip.

In the embodiment of the present disclosure, the attachment and detachment of the storage body to and from an object are realized by a belt, a string, a magnet, a hook-and-loop fastener, a button, a clip, or the like.

In the storage body according to the embodiment of the present disclosure, an opening causing the first storage chamber to communicate with an outside is formed in the first storage chamber.

In the embodiment of the present disclosure, a battery included in the wireless charger is replaced or is charged through the opening.

The storage body according to the embodiment of the present disclosure further includes an opening/closing unit that opens and closes the opening.

In the embodiment of the present disclosure, the opening is opened and closed as necessary by the opening/closing unit, so that a battery is replaced or charged and the fall-out of the battery is prevented.

A storage body according to an embodiment of the present disclosure includes a first storage chamber in which a wireless charger is stored, a second storage chamber which is adjacent to the first storage chamber and in which a portable terminal to be charged by the wireless charger is to be stored, and a positioning tool that positions the portable terminal at a position where the portable terminal is capable of being charged on the wireless charger.

In the embodiment of the present disclosure, in a case where the portable terminal is stored in the second storage chamber, the portable terminal is positioned at a position where the portable terminal can be charged by the positioning tool. Further, the portable terminal is charged by the wireless charger stored in the first storage chamber.

In the storage body according to the embodiment of the present disclosure, the first storage chamber and the second storage chamber form a pocket of a garment or a bag.

In the embodiment of the present disclosure, a pocket of a garment or a bag is used as the storage chamber.

A storage body according to an embodiment of the present disclosure includes a storage chamber in which a wireless charger for charging a portable terminal is stored, an attachment/detachment tool that attaches the wireless charger to the storage chamber and detaches the wireless charger from the storage chamber, and a positioning tool that positions the portable terminal at a position where the portable terminal is capable of being charged on the wireless charger.

In the embodiment of the present disclosure, in a case where the portable terminal is stored in the storage chamber, the portable terminal is positioned at a position where the portable terminal can be charged by the positioning tool. Further, the portable terminal is charged by the wireless charger stored in the storage chamber. Furthermore, the wireless charger can be detached from the storage chamber as necessary.

In the storage body according to the embodiment of the present disclosure, the wireless charger includes a charging surface facing the portable terminal, and the positioning tool includes a recessed portion that is formed on the charging surface and a protruding portion that is provided on the portable terminal and is fitted into the recessed portion.

In the embodiment of the present disclosure, the positioning of the portable terminal is realized by the recessed portion formed on the charging surface and the protruding portion provided on the portable terminal.

In the storage body according to the embodiment of the present disclosure, the wireless charger includes a charging surface facing the portable terminal and the positioning tool includes a protruding portion formed on the charging surface.

In the embodiment of the present disclosure, the positioning of the portable terminal is realized by the protruding portion formed on the charging surface.

In the storage body according to the embodiment of the present disclosure, the storage chamber forms a pocket of a garment or a bag.

In the embodiment of the present disclosure, a pocket of a garment or a bag is used as the storage chamber.

A storage body according to an embodiment of the present disclosure includes a wireless charger that includes a charging surface, a facing part that faces the charging surface, and a storage chamber which is formed between the charging surface and the facing part and in which a portable terminal to be charged by the wireless charger is to be stored.

In the embodiment of the present disclosure, the storage chamber is formed between the charging surface and the facing part and the portable terminal is stored in the storage chamber, so that the charging of the portable terminal is realized.

A method of manufacturing a storage body according to an embodiment of the present disclosure includes: receiving a selection of a design for a storage body including a wireless charger that includes a charging surface, a facing part that faces the charging surface, and a storage chamber which is formed between the charging surface and the facing part and in which a portable terminal to be charged by the wireless charger is to be stored; and applying the received design to the facing part or the wireless charger.

In the embodiment of the present disclosure, a design selected by a user is applied to the storage body.

A garment according to an embodiment of the present disclosure includes: a garment body; a first storage chamber which is formed on the garment body and in which a wireless charger is stored to be capable of being taken out; a second storage chamber which is adjacent to the first storage chamber and in which a portable terminal to be charged by the wireless charger is to be stored; and the wireless charger that is stored in the first storage chamber and charges the portable terminal in a state where the portable terminal stored in the second storage chamber is positioned at a position where the portable terminal is capable of being charged by a magnetic force.

In the embodiment of the present disclosure, in a case where the portable terminal is stored in the second storage chamber, the portable terminal is positioned at a position where the portable terminal can be charged by a magnetic force. Further, the portable terminal is charged by the wireless charger stored in the first storage chamber.

A method of attaching a wireless charger according to an embodiment of the present disclosure includes: providing an attachment/detachment tool on at least one of a storage chamber and a wireless charger; and detachably attaching the wireless charger to the storage chamber through the attachment/detachment tool.

In the embodiment of the present disclosure, the wireless charger can be detached from the storage chamber as necessary.

In the storage body according to the embodiment of the present disclosure, in a case where the portable terminal is stored in the second storage chamber, the portable terminal is charged by the wireless charger stored in the first storage chamber. Further, a user can mount the storage body on an object to be used by the user, for example, a bag or a garment by using the attachment/detachment tool. The user can charge the portable terminal only by storing the portable terminal in the storage body and mounting the storage body on an object to be used by the user, and can also suppress the burden of carrying the storage body.

In the storage body according to the embodiment of the present disclosure, in a case where the portable terminal is stored in the second storage chamber, the portable terminal can be positioned at a position where the portable terminal can be charged by the positioning tool and can be charged by the wireless charger stored in the first storage chamber.

In the storage body according to the embodiment of the present disclosure, in a case where the portable terminal is stored in the storage chamber, the portable terminal can be positioned at a position where the portable terminal can be charged by the positioning tool and can be charged by the wireless charger stored in the storage chamber. Further, the wireless charger can be detached from the storage chamber as necessary.

In the storage body according to the embodiment of the present disclosure, the storage chamber is formed between the charging surface and the facing part and the portable terminal is stored in the storage chamber, so that the charging of the portable terminal can be realized.

In the method of attaching a wireless charger according to the embodiment of the present disclosure, the wireless charger can be detached from the storage chamber as necessary.

The above and further objects and features will more fully be apparent from the following detailed description with accompanying drawings.

### BRIEF DESCRIPTION OF THE DRAWINGS

FIG. 1 is a schematic perspective view of a storage body according to a first embodiment.

FIG. 2 is a schematic left side cross-sectional view of the storage body.

FIG. 3 is a schematic cross-sectional view taken along line 3-3 shown in FIG. 2 as a section line.

FIG. 4 is a schematic cross-sectional view taken along line 4-4 shown in FIG. 3 as a section line.

FIG. 5 is a schematic partial rear view of a housing 1.

FIG. 6 is a schematic left side view of a storage body according to a second embodiment.

FIG. 7 is a partial perspective view schematically showing a storage body according to a third embodiment.

FIG. 8 is a partial cross-sectional view of a storage body according to a fourth embodiment as visually recognized from a rear side.

FIG. 9 is a schematic plan cross-sectional view of a storage body according to a fifth embodiment.

FIG. 10 is a schematic plan cross-sectional view of the storage body.

FIG. 11 is a schematic plan cross-sectional view of the storage body.

FIG. 12 is a schematic right side cross-sectional view of a storage body according to a sixth embodiment.

FIG. 13 is a schematic right side cross-sectional view of the storage body in a case where a smartphone is stored in a second storage chamber.

FIG. 14 is a schematic right side cross-sectional view of a storage body according to a seventh embodiment.

FIG. 15 is a schematic right side cross-sectional view of the storage body in a case where a smartphone is stored in a storage chamber.

FIG. 16 is a schematic right side cross-sectional view of a storage body according to an eighth embodiment.

FIG. 17 is a schematic right side cross-sectional view of the storage body in a case where a smartphone 30 is stored in a storage chamber.

FIG. 18 is a schematic front view of a storage body according to a ninth embodiment.

FIG. 19 is a schematic right side view of the storage body.

FIG. 20 is a schematic back view of the storage body.

FIG. 21 is a schematic bottom view of the storage body.

FIG. 22 is a schematic front view of the storage body in which a smartphone is stored in a storage chamber.

FIG. 23 is a schematic front view of the storage body having designs on the surfaces thereof.

FIG. 24 is a schematic right side view of the storage body having designs on the surfaces thereof.

FIG. 25 is a schematic back view of the storage body having designs on the surfaces thereof.

### DETAILED DESCRIPTION OF NON-LIMITING EXAMPLE EMBODIMENTS

### First Embodiment

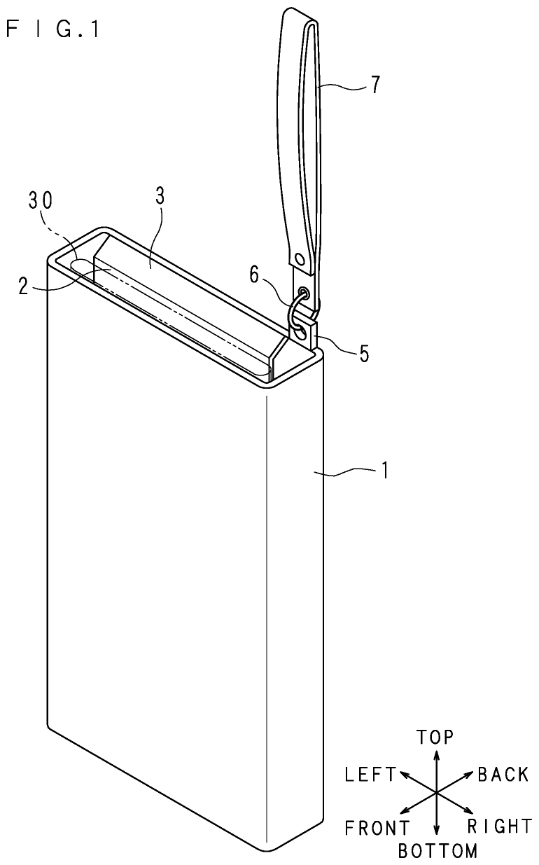

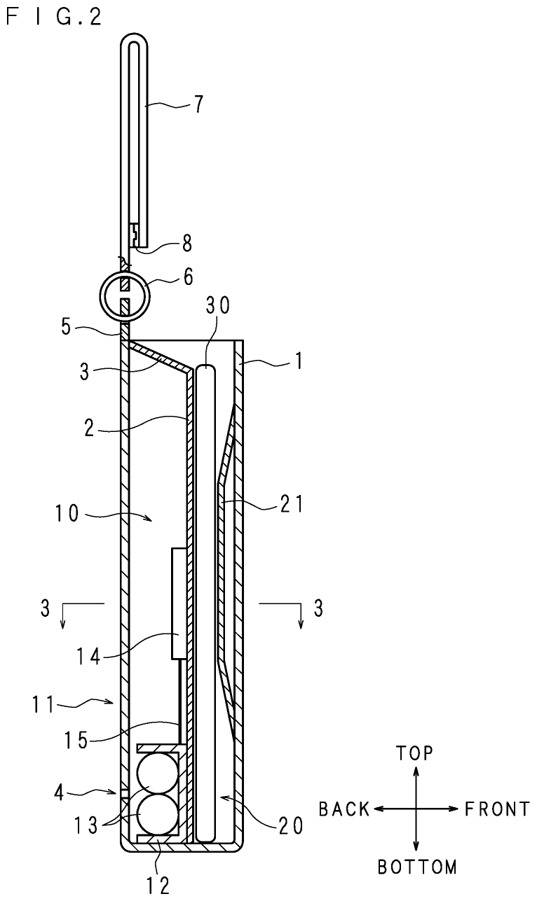

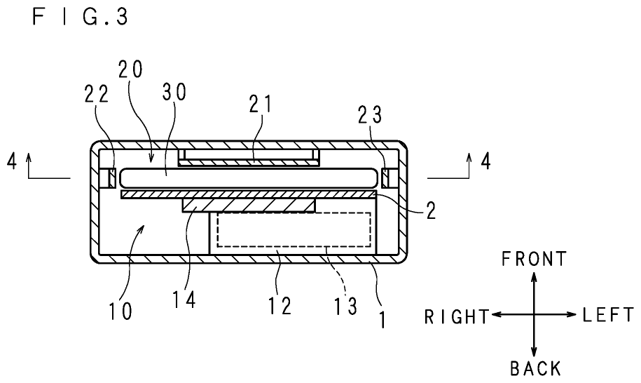

The present invention will be described below with reference to the drawings showing a storage body according to a first embodiment. An upper side, a lower side, a front side, a rear side, a left side, and a right side in the drawings will be used in the following description. FIG. 1 is a schematic perspective view of the storage body, FIG. 2 is a schematic left side cross-sectional view of the storage body, and FIG. 3 is a schematic cross-sectional view taken along line 3-3 shown in FIG. 2 as a section line.

The storage body includes a housing 1 that has the shape of a flat rectangular parallelepiped extending in one direction. One end surface portion of the housing 1 is open. The housing 1 is disposed so that this one end surface portion is an upper surface portion and the other end surface portion of the housing 1 is a lower surface portion.

The housing 1 includes two side surface portions having a large area and two side surface portions having a small area. The housing 1 is disposed so that the two side surface portions having a large area are a front surface portion and a rear surface portion and the two side surface portions having a small area are a right surface portion and a left surface portion.

A partition wall 2 is provided in the housing 1. The partition wall 2 has the shape of a rectangular plate substantially parallel to the front surface portion and the rear surface portion of the housing 1, and is disposed substantially in the middle between the front surface portion and the rear surface portion in a front-rear direction. Four sides of the partition wall 2 face the upper side, the lower side, the left side, and the right side, respectively. The partition wall 2 extends in an up-down direction, the upper side of the partition wall 2 is disposed below an upper end of the housing 1, and the lower side of the partition wall 2 is close to the lower surface portion of the housing 1. The lower side of the partition wall 2 is not connected to the lower surface portion of the housing 1. The lower side of the partition wall 2 may be connected to the lower surface portion of the housing 1. The left side of the partition wall 2 and the left surface portion of the housing 1 are not connected to each other and a gap is provided between the left side of the partition wall 2 and the left surface portion of the housing 1. The right side of the partition wall 2 and the right surface portion of the housing 1 are not connected to each other and a gap is provided between the right side of the partition wall 2 and the right surface portion of the housing 1. The left side of the partition wall 2 and the left surface portion of the housing 1 may be connected to each other, or the right side of the partition wall 2 and the right surface portion of the housing 1 may be connected to each other.

The upper side of the partition wall 2 and an upper side of the rear surface portion of the housing 1 are connected to each other by a cover 3. The cover 3 has the shape of a rectangular plate and extends in a left-right direction. Long side portions of the cover 3 are connected to the upper side of the partition wall 2 and the upper side of the rear surface portion of the housing 1, respectively. The cover 3 is inclined to descend toward the front side.

A first storage chamber 10 is formed by the rear surface portion, the lower surface portion, the right surface portion, and the left surface portion of the housing 1, the rear surface of the partition wall 2, and the cover 3. A wireless charger 11 is stored in the first storage chamber 10. The wireless charger 11 includes a battery case 12, batteries 13, a power transmission unit 14, and wiring 15.

The battery case 12 has the shape of a rectangular parallelepiped of which one surface is open, and is attached to the lower left corner of the rear surface of the partition wall 2 so that the one surface faces the rear side. One or a plurality of batteries 13 are stored in the battery case 12. The power transmission unit 14 includes a power transmission coil, and is attached to the central portion of the rear surface of the partition wall 2. The batteries 13 and the power transmission unit 14 are connected to each other by the wiring 15. The power transmission unit 14 is sufficiently thinner than the battery case 12 and the batteries 13, and, for example, the width of the power transmission unit 14 in the front-rear direction is 5 mm or less.

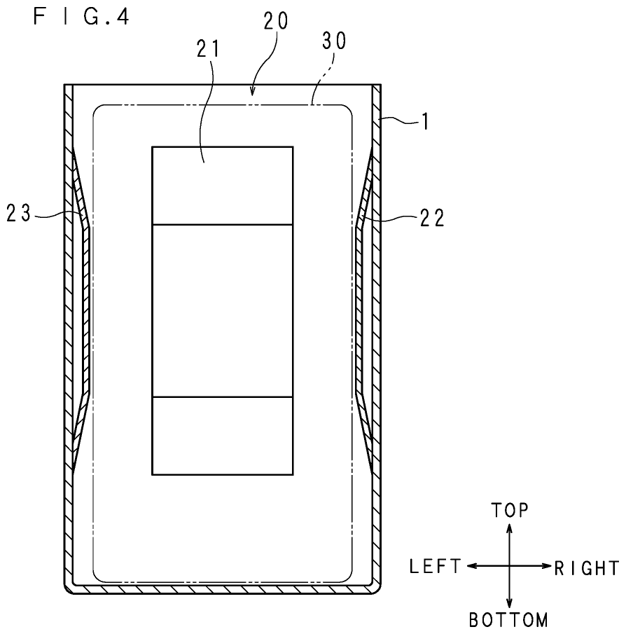

FIG. 4 is a schematic cross-sectional view taken along line 4-4 shown in FIG. 3 as a section line. A second storage chamber 20 is formed by the front surface portion, the lower surface portion, the right surface portion, and the left surface portion of the housing 1 and the front surface of the partition wall 2. An upper side of the second storage chamber 20 is open. A smartphone 30 having the shape of a rectangular plate is stored in the second storage chamber 20.

In the second storage chamber 20, a first guide 21 protruding toward the rear side is provided on the rear surface of the front surface portion of the housing 1. In a case where the first guide 21 is visually recognized from the front side, the first guide 21 has a rectangular shape extending in the up-down direction as shown in FIG. 4. An upper end of the first guide 21 is positioned below an upper edge of the front surface portion of the housing 1, and a lower end of the first guide 21 is positioned above a lower edge of the front surface portion of the housing 1.

As shown in FIG. 2, an upper portion of the first guide 21 is inclined to approach the front surface portion of the housing 1 toward the upper side. A lower portion of the first guide 21 is inclined to approach the front surface portion of the housing 1 toward the lower side. A middle portion of the first guide 21 in the up-down direction is substantially parallel to the partition wall 2 and the front surface portion of the housing 1. A protruding width (the width in the front-rear direction) of the first guide 21 is smaller than a width between the front surface portion of the housing 1 and the partition wall 2 in the front-rear direction. The width between the first guide 21 and the partition wall 2 in the front-rear direction is substantially equal to the thickness of the smartphone 30.

As shown in FIG. 4, a second guide 22 protruding toward the left side is provided on the left surface of the right surface portion of the housing 1. In a case where the second guide 22 is visually recognized from the left side, the second guide 22 has the shape of a strip extending in the up-down direction. An upper end of the second guide 22 is positioned below an upper edge of the right surface portion of the housing 1, and a lower end of the second guide 22 is positioned above a lower edge of the right surface portion of the housing 1.

As shown in FIG. 4, an upper portion of the second guide 22 is inclined to approach the right surface portion of the housing 1 toward the upper side. A lower portion of the second guide 22 is inclined to approach the right surface portion of the housing 1 toward the lower side. A middle portion of the second guide 22 in the up-down direction is substantially parallel to the right surface portion of the housing 1.

As shown in FIG. 4, a third guide 23 protruding toward the right side is provided on the right surface of the left surface portion of the housing 1. In a case where the third guide 23 is visually recognized from the right side, the third guide 23 has the shape of a strip extending in the up-down direction. An upper end of the third guide 23 is positioned below an upper edge of the left surface portion of the housing 1, and a lower end of the third guide 23 is positioned above a lower edge of the left surface portion of the housing 1.

As shown in FIG. 4, an upper portion of the third guide 23 is inclined to approach the left surface portion of the housing 1 toward the upper side. A lower portion of the third guide 23 is inclined to approach the left surface portion of the housing 1 toward the lower side. A middle portion of the third guide 23 in the up-down direction is substantially parallel to the left surface portion of the housing 1.

In the second storage chamber 20, a width between the second guide 22 and the third guide 23 in the left-right direction is substantially equal to the width of a short side of the smartphone 30. The width of the second storage chamber 20 in the up-down direction, that is, the width of the housing 1 in the up-down direction is slightly larger than the width of a long side of the smartphone 30.

In a case where the smartphone 30 is stored in the second storage chamber 20 so that the back surface of the smartphone 30 faces the partition wall 2, the smartphone 30 is positioned in the front-rear direction and the left-right direction by the partition wall 2, the first guide 21, the second guide 22, and the third guide 23.

The smartphone 30 includes a power receiving unit (not shown) that is supplied with power. The power receiving unit includes a power receiving coil. The power receiving unit of the smartphone 30 stored in the second storage chamber 20 faces the power transmission unit 14. That is, the smartphone 30 is positioned at a power receiving position where the smartphone 30 can receive power supplied from the power transmission unit by the partition wall 2, the first guide 21, the second guide 22, and the third guide 23. Power accumulated in the batteries 13 is supplied to the smartphone 30 through the power transmission unit 14 and the power receiving unit.

The width of the housing 1 in the left-right direction is substantially equal to the sum of the width of the short side of the smartphone 30 and the widths of the second guide 22 and the third guide in the left-right direction. The width of the housing 1 in the up-down direction is slightly larger than the width of the long side of the smartphone 30. In other words, the width of the housing 1 in the left-right direction and the width of the housing 1 in the up-down direction correspond to the widths of the short side and the long side of the smartphone 30. The width of the second storage chamber 20 in the front-rear direction corresponds to the width of the first guide 21 and the smartphone 30 in the front-rear direction, and the width of the first storage chamber 10 in the front-rear direction corresponds to the width of the battery case 12 and the battery 13 in the front-rear direction. That is, the storage body is designed to have minimum dimensions required to store the wireless charger 11 and the smartphone 30.

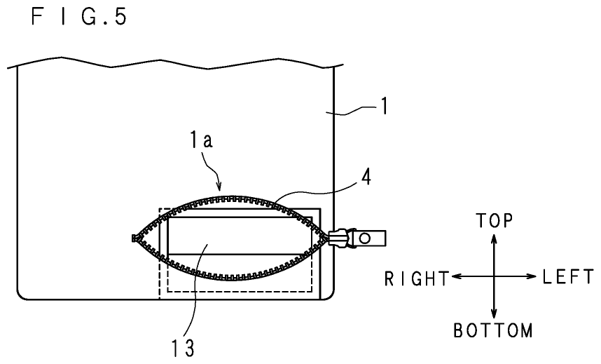

FIG. 5 is a schematic partial rear view of the housing 1. As shown in FIG. 5, an opening 1a passing through the rear surface of the housing in the front-rear direction is formed at the lower left corner of the rear surface of the housing 1. A zipper 4 is attached to the opening 1a, and the opening 1a is opened and closed by the zipper 4. The position of the opening 1a corresponds to the positions of the batteries 13 in the up-down direction and the left-right direction. In a case where the opening 1a is opened, the first storage chamber 10 communicates with the outside and the batteries 13 are exposed to the outside. Accordingly, the batteries 13 can be replaced. The positions of the batteries 13 and the opening 1a are not limited to the lower left corner of the rear surface of the housing 1, and have only to correspond to each other. For example, the batteries 13 and the opening 1a may be disposed in the middle portion of the lower end of the rear surface of the housing 1 or at the lower right corner of the rear surface of the housing 1.

The zipper 4 is merely one example of an opening/closing unit for opening and closing the opening 1a, and a hook-and-loop fastener, a button, a magnet, or the like may be used instead of the zipper 4.

As shown in FIGS. 1 and 2, a tongue portion 5 protruding upward is provided at the right end portion of the upper edge of the rear surface portion of the housing 1. The tongue portion 5 has a rectangular shape parallel to the rear surface portion. A hole passing through the tongue portion in the front-rear direction is formed in the tongue portion 5. A belt 7 is connected to the tongue portion 5. Both end portions of the belt 7 are connected to each other by a connection tool 8. The connection tool 8 includes, for example, a male button and a female button. In FIG. 2, the male button is attached to one end portion of the belt 7 and the female button is attached to the other end portion of the belt 7. The male button is disposed closer to the other end portion than one end of the belt 7.

A ring 6 penetrates a portion of the belt 7 between one end of the belt 7 and the male button, and the ring 6 is inserted into the hole of the tongue portion 5. That is, the belt 7 and the tongue portion 5 are connected to each other by the ring 6. In a state where the connection of the connection tool 8 is released, a user can attach the storage body to a bag by causing the other end of the belt 7 to pass through the inside of a handle of the bag and connecting the male button and the female button (connection tool 8). In a case where the storage body is unnecessary, the user can detach the storage body from the bag by releasing the connection of the connection tool 8. The belt 7 can also be attached to an object other than the bag, for example, a belt loop of pants. The female button may be attached to one end portion of the belt 7 and the male button may be attached to the other end portion of the belt 7. The female button and the male button may be a snap type or a magnetic type. A string may be used instead of the belt 7. Further, an elastic annular band may be used instead of the belt 7. In this case, when, for example, a band is attached to the rear surface portion of the housing 1, the storage body can be mounted on the user's arm or leg.

In the storage body according to the first embodiment, the smartphone 30 is charged by the wireless charger 11 stored in the first storage chamber 10 in a case where the smartphone 30 is stored in the second storage chamber 20. Further, a user can mount the storage body on an object to be used by the user, for example, a bag by using the belt 7. The user can charge the smartphone 30 only by storing the smartphone 30 in the storage body and mounting the storage body on an object to be used by the user. Furthermore, the storage body can be designed to be small and the burden of carrying the storage body can be suppressed.

Further, the smartphone 30 is positioned at the power receiving position by the first to third guides 21 to 23, so that the smartphone 30 can be reliably charged. Furthermore, an object can be attached and detached by the belt 7 and the connection tool 8. Moreover, the batteries 13 can be replaced through the opening 1a. Further, the opening 1a is opened and closed as necessary by the zipper 4, so that both the replacement of the batteries and the prevention of the fall-out of the batteries 13 can be achieved.

Furthermore, since the upper side of the first storage chamber 10 is closed by the cover 3, it is possible to prevent a user from storing the smartphone 30 in the first storage chamber 10 by mistake. Moreover, since the cover 3 is inclined toward the second storage chamber 20, the cover 3 can guide the smartphone 30 to the second storage chamber 20.

The first to third guides 21 to 23 described above may be plates that are perpendicular to wall surfaces of the second storage chamber 20 and extend in the up-down direction. Further, the cover 3 may be removed and an upper edge portion of the partition wall 2 may be directly fixed to the rear surface portion of the housing 1. The smartphone 30 is merely an example of a portable terminal, and, for example, a personal data assistant (PDA) or a tablet terminal may be stored in the second storage chamber 20.

The wireless charger 11 may be adapted to be attached to and detached from the partition wall 2. Since the lower side of the partition wall 2 is not connected to the lower surface portion of the housing 1 as described above, the partition wall 2 can be taken out of the housing 1. Even in a case where the wireless charger 11 is not mounted on the partition wall 2, for example, even in a case where the storage body is sold in a state where the wireless charger 11 is not mounted, a user can mount a wireless charger 11, which is separately purchased, on the partition wall 2 taken out of the housing 1 and return the partition wall 2 to the inside of the housing 1. Further, even though the wireless charger 11 has been mounted on the partition wall 2, the wireless charger 11 can be repaired and replaced in a case where a problem occurs in the wireless charger 11.

The dimensions and the orientation of the opening 1a may be set to dimensions and an orientation that allow the wireless charger 11 to be taken out, and the wireless charger 11 may be taken out or attached through the opening 1a. For example, the opening 1a may be designed to be long in the left-right direction and the width of the opening 1a in the left-right direction may be designed to be substantially equal to the width of the housing 1 in the left-right direction, or the opening 1a may be designed to be long in the up-down direction and the width of the opening 1a in the up-down direction may be designed to be substantially equal to the width of the housing 1 in the up-down direction.

A region of the front surface portion of the housing 1 corresponding to at least a display screen of the smartphone 30 may be formed of a translucent member or a transparent member. In this case, a user can visually recognize the display screen from the outside and can operate icons displayed on the display screen.

A member having an elastic force, for example, a rubber material, a spring, a polyurethane material, or the like may be used for the first to third guides 21 to 23. Since the first to third guides 21 to 23 have an elastic force, a plurality of types of smartphones 30 having different dimensions can be positioned at the power receiving position. Further, the shape of the housing 1 is not limited to the shape of a rectangular parallelepiped, and may be other shapes, such as the shape of the other polyhedron (for example, a regular icosahedron), a cylindrical shape, and a spherical shape.

### Second Embodiment

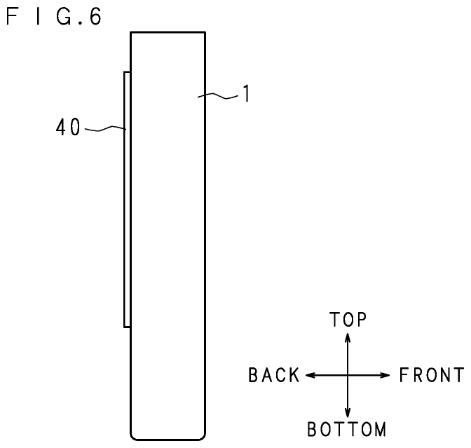

The present invention will be described below with reference to the drawing showing a storage body according to a second embodiment. The same components as the components of the first embodiment among components of the second embodiment will be denoted by the same reference numerals as those of the first embodiment, and the detailed description thereof will be omitted. FIG. 6 is a schematic left side view of the storage body. In the second embodiment, the storage body includes a hook-and-loop fastener 40 instead of the connection tool 8 of the first embodiment. The hook-and-loop fastener 40 is attached to the rear surface of a housing 1. The hook-and-loop fastener 40 allows the storage body to be attached to and detached from a fabric object. For example, the storage body can be attached to and detached from a fabric bag or a garment. Meanwhile, a magnet may be attached to the rear surface of the housing 1 instead of the hook-and-loop fastener 40. In this case, the storage body can be attached to and detached from an object including a magnetic body. The attachment and detachment of the storage body to and from an object can be realized by the hook-and-loop fastener 40 or the magnet.

### Third Embodiment

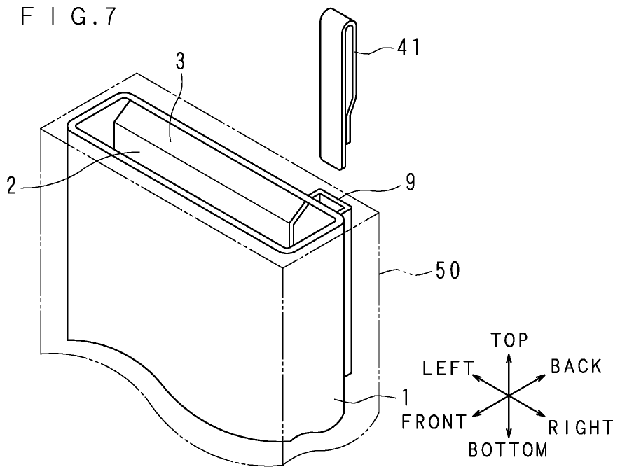

The present invention will be described below with reference to the drawing showing a storage body according to a third embodiment. The same components as the components of the first or second embodiment among components of the third embodiment will be denoted by the same reference numerals as those of the first or second embodiment, and the detailed description thereof will be omitted. FIG. 7 is a partial perspective view schematically showing the storage body. A tubular body 9 of which an axial direction is parallel to the up-down direction is provided on the rear surface of the housing 1.

The storage body is put in a pocket 50 of a bag, a garment, or the like, one end portion of a U-shaped clip 41 is inserted into the tubular body 9 and the tubular body 9 and one surface of the pocket 50 are held by the clip 41. Accordingly, the storage body can be attached to the pocket 50. The clip 41 is pulled out of the tubular body 9, so that the storage body can be detached from the pocket 50.

Meanwhile, the clip 41 may be attached to the housing 1 and the pocket 50 without the tubular body 9. Further, a string that includes clips attached to both end portions thereof may be used instead of the clip 41, and both clips may be attached to the pocket 50 and the tubular body 9 or the housing 1, respectively.

### Fourth Embodiment

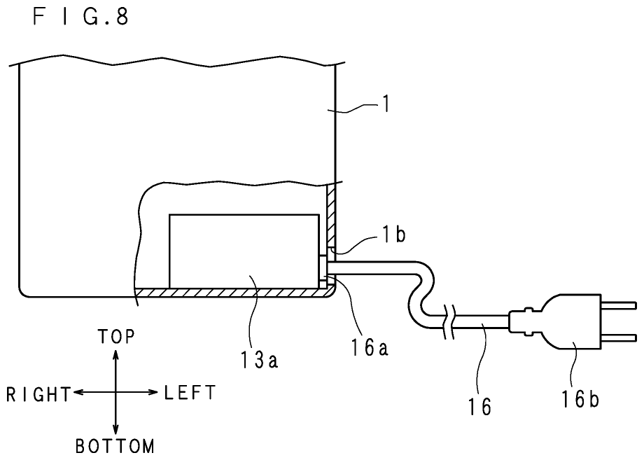

The present invention will be described below with reference to the drawing showing a storage body according to a fourth embodiment. The same components as the components of the first to third embodiments among components of the fourth embodiment will be denoted by the same reference numerals as those of the first to third embodiments, and the detailed description thereof will be omitted. FIG. 8 is a partial cross-sectional view of the storage body as visually recognized from the rear side. A wireless charger 11 includes a rechargeable battery 13a. An opening 1b passing through the left surface portion of a housing 1 in the left-right direction is formed at the lower end portion of the left surface portion of the housing 1. The width of the opening 1b in the up-down direction is smaller than that of the rechargeable battery 13a. Accordingly, the rechargeable battery 13a does not fall out from the opening 1b.

The rechargeable battery 13a includes a terminal (not shown) for charging. The rechargeable battery 13a is stored in a first storage chamber 10 so that the terminal faces the opening 1b. In a case where a user charges the rechargeable battery 13a, the user uses a cord 16 for charging. One end portion of the cord 16 is provided with a first terminal 16a to be connected to the terminal of the rechargeable battery 13a, and the other end portion of the cord 16 is provided with a second terminal 16b to be connected to a power source. In a case where the first terminal 16a is connected to the terminal of the rechargeable battery 13a and the second terminal 16b is connected to the power source, the rechargeable battery 13a can be charged. Meanwhile, an opening/closing unit for opening and closing the opening 1b may be provided.

### Fifth Embodiment

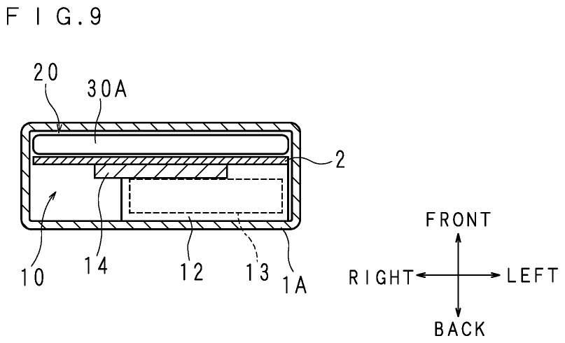

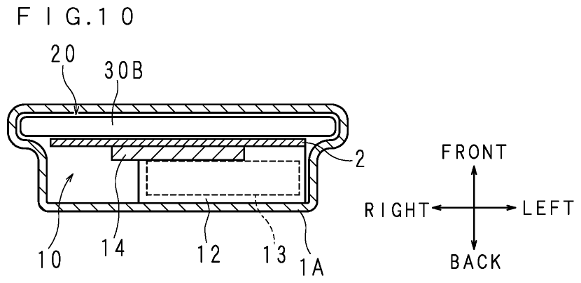

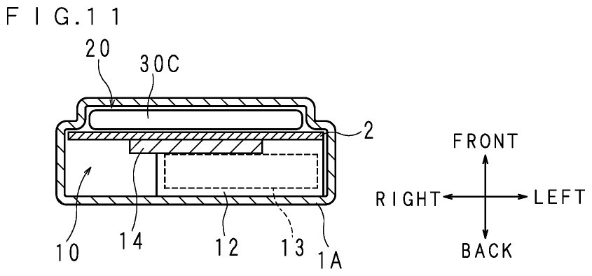

The present invention will be described below with reference to the drawings showing a storage body according to a fifth embodiment. The same components as the components of the first to fourth embodiments among components of the fifth embodiment will be denoted by the same reference numerals as those of the first to fourth embodiments, and the detailed description thereof will be omitted. FIGS. 9 to 11 are schematic plan cross-sectional views of the storage body. FIG. 9 shows the storage body in which a first smartphone 30A is stored in a second storage chamber 20, FIG. 10 shows the storage body in which a second smartphone 30B is stored in the second storage chamber 20, and FIG. 11 shows the storage body in which a third smartphone 30C is stored in the second storage chamber 20.

The storage body does not include the first to third guides 21 to 23. A housing 1A of the storage body is formed of a member having stretchability, for example, a rubber material or cloth having stretchability. The first smartphone 30A has, for example, substantially the same dimension as the partition wall 2 in the left-right direction. The dimension of the second smartphone 30B in the left-right direction is larger than the dimension of the first smartphone 30A in the left-right direction. The dimension of the third smartphone 30C in the left-right direction is smaller than the dimension of the first smartphone 30A in the left-right direction.

As shown in FIG. 9, the first smartphone 30A is stored in the second storage chamber 20 and an inner peripheral surface of the second storage chamber 20 is close to the first smartphone 30A.

As shown in FIG. 10, the second smartphone 30B is stored in the second storage chamber 20. The left and right portions of the second smartphone 30B protrude outward from the left and right ends of the partition wall 2, and the second storage chamber 20 extends in the left-right direction to correspond to the dimension of the second smartphone 30B in the left-right direction as compared to a case where the first smartphone 30A is stored. The inner peripheral surface of the second storage chamber 20 is close to the second smartphone 30B.

As shown in FIG. 11, the third smartphone 30C is stored in the second storage chamber 20. The left and right portions of the third smartphone 30C are positioned closer to the inside than the left and right ends of the partition wall 2, and the second storage chamber 20 contracts in the left-right direction to correspond to the dimension of the third smartphone 30C in the left-right direction as compared to a case where the first smartphone 30A is stored. The inner peripheral surface of the second storage chamber 20 is close to the third smartphone 30C.

Since the second storage chamber 20 extends and contracts depending on smartphones having different dimensions even though the first to third guides 21 to 23 are not used in the storage body according to the fifth embodiment, a plurality of types of smartphones having different specifications can be stored in the second storage chamber 20 and can be positioned at the power receiving position.

Since the second storage chamber 20 can extend and contract with regard to a dimension in the front-rear direction, a plurality of types of smartphones having different dimensions in the front-rear direction can be stored. The housing 1A may be molded in two colors, the second storage chamber 20 may be formed of a member having high stretchability, and the first storage chamber 10 may be formed of a member having low stretchability.

### Sixth Embodiment

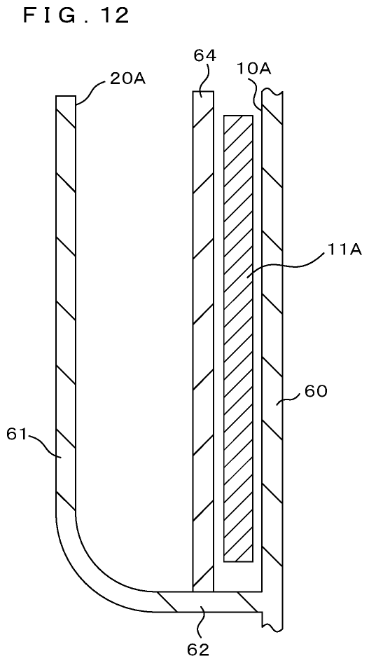

The present invention will be described below with reference to the drawings showing a storage body according to a sixth embodiment. The same components as the components of the first to fifth embodiments among components of the sixth embodiment will be denoted by the same reference numerals as those of the first to fifth embodiments, and the detailed description thereof will be omitted. FIG. 12 is a schematic right side cross-sectional view of the storage body. The storage body according to the sixth embodiment is, for example, a pocket of a garment or a bag.

The storage body includes a support part 60, a facing part 61, and a bottom part 62. The support part 60 has the shape of a thin flat plate, and includes a front surface and a rear surface. The facing part 61 has the shape of a thin flat plate, and includes a front surface and a rear surface. The facing part 61 and the support part 60 are apart from each other in the front-rear direction, and the rear surface of the facing part 61 and the front surface of the support part 60 face each other. The bottom part 62 has the shape of a thin flat plate, and includes an upper surface and a lower surface. The bottom part 62 connects a lower edge of the facing part 61 to the front surface of the support part 60. A partition wall 64 extends upward from the upper surface of the bottom part 62. The partition wall 64 includes a front surface and a rear surface.

A chamber surrounded by the rear surface of the partition wall 64, the front surface of the support part 60, and the upper surface of the bottom part 62 forms a first storage chamber 10A. An upper surface of the first storage chamber 10A is open. A chamber surrounded by the front surface of the partition wall 64, the rear surface of the facing part 61, and the upper surface of the bottom part 62 forms a second storage chamber 20A. A wireless charger 11A including a rechargeable battery, a power transmission unit, a magnetic body, and an adapter (all of them are not shown) is stored in the first storage chamber 10A. The magnetic body is disposed at a predetermined position in the wireless charger 11A. The wireless charger 11A can charge the rechargeable battery through the adapter.

The wireless charger 11A is taken out of the first storage chamber 10A as necessary. For example, in a case where a garment including the storage body is to be washed or in a case where the rechargeable battery built in the wireless charger 11A is to be charged, the wireless charger 11A can be taken out of the first storage chamber 10A.

The support part 60 is, for example, a part of a garment body, and the facing part 61 and the bottom part 62 are a pocket formed on the garment body. The partition wall 64 is provided in the pocket, so that the first storage chamber 10A and the second storage chamber 20A are formed.

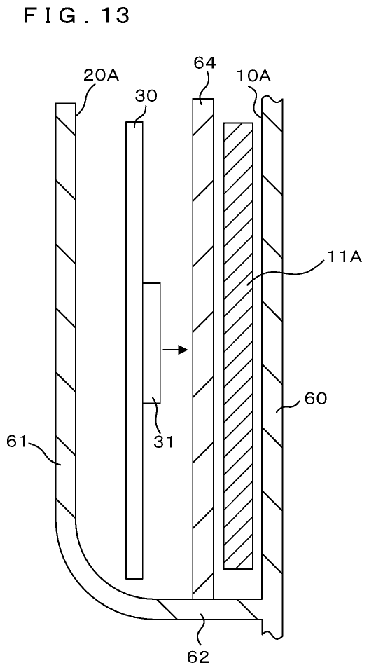

FIG. 13 is a schematic right side cross-sectional view of the storage body in a case where a smartphone 30 is stored in the second storage chamber 20A. The smartphone 30 includes a front surface and a rear surface, and a screen is disposed on the front surface. A positioning tool 31 is attached to the rear surface of the smartphone 30. The positioning tool 31 includes a magnet. In a case where the smartphone 30 is stored in the second storage chamber 20A so that the positioning tool 31 is disposed on the rear side, the positioning tool 31 attracts the magnetic body disposed at a predetermined position in the wireless charger 11A as shown by an arrow of FIG. 13. The smartphone 30 is positioned at a position where the smartphone 30 can be charged on the front surface of the wireless charger 11A.

In the storage body according to the sixth embodiment, a user can charge the smartphone 30 only by storing the smartphone 30 in the storage body, such as a pocket. That is, since the smartphone 30 is charged while a user carries the smartphone 30 even in a case where the user frequently uses the smartphone 30, it is possible to suppress the running out of the battery of the smartphone 30.

### Seventh Embodiment

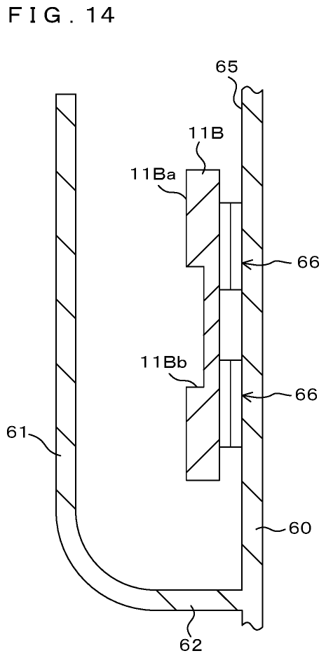

The present invention will be described below with reference to the drawings showing a storage body according to a seventh embodiment. The same components as the components of the first to sixth embodiments among components of the seventh embodiment will be denoted by the same reference numerals as those of the first to sixth embodiments, and the detailed description thereof will be omitted. FIG. 14 is a schematic right side cross-sectional view of the storage body. The storage body according to the seventh embodiment is, for example, a pocket of a garment or a bag.

As in the sixth embodiment, the storage body according to the seventh embodiment includes a support part 60, a facing part 61, and a bottom part 62. The storage body according to the seventh embodiment does not include the partition wall 64 unlike in the sixth embodiment. A chamber surrounded by a rear surface of the facing part 61, a front surface of the support part 60, and an upper surface of the bottom part 62 forms a storage chamber. A wireless charger 11B including a rechargeable battery, a power transmission unit, a magnetic body, and an adapter (all of them are not shown) is provided on the front surface of the support part 60.

The wireless charger 11B includes a front surface and a rear surface. The front surface forms a charging surface 11Ba. A recessed portion 11Bb is formed on the charging surface 11Ba. The magnetic body is provided on the bottom surface of the recessed portion 11Bb. A rear surface of the wireless charger 11B faces the front surface of the support part 60. An attachment/detachment tool 66 is attached between the rear surface of the wireless charger 11B and the front surface of the support part 60. The wireless charger 11B is attached to the support part 60 through the attachment/detachment tool 66. The attachment/detachment tool 66 is, for example, a hook-and-loop fastener. The attachment/detachment tool 66 is not limited to the hook-and-loop fastener and may be a magnet, a button, or the like.

The wireless charger 11B is detached from the support part 60 as necessary. For example, in a case where a garment including the storage body is to be washed or in a case where the rechargeable battery built in the wireless charger 11B is to be charged, the wireless charger 11B can be detached from the support part 60.

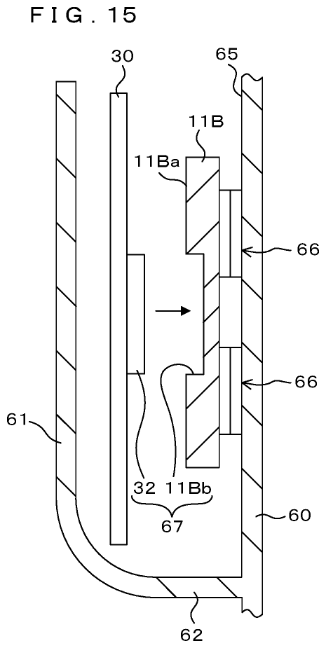

FIG. 15 is a schematic right side cross-sectional view of the storage body in a case where a smartphone 30 is stored in the storage chamber. The smartphone 30 includes a front surface and a rear surface, and a screen is disposed on the front surface. A protruding portion 32 is attached to the rear surface of the smartphone 30. The protruding portion 32 includes a magnet. In a case where the smartphone 30 is stored in the second storage chamber 20A so that the protruding portion 32 faces the rear side, the protruding portion 32 is fitted into the recessed portion 11Bb of the wireless charger 11B. Accordingly, the smartphone 30 is positioned at a position where the smartphone 30 can be charged on the front surface of the wireless charger 11B. Since the magnet of the protruding portion 32 attracts the magnetic body of the recessed portion 11Bb as shown by an arrow of FIG. 15, the protruding portion 32 and the recessed portion 11Bb can be smoothly fitted to each other. The recessed portion 11Bb and the protruding portion 32 form a positioning tool 67. The recessed portion 11Bb and the protruding portion 32 may not be formed and the magnetic body of the wireless charger 11B and the magnet of the smartphone 30 are attracted to each other, so that the smartphone 30 may be positioned.

In the storage body according to the seventh embodiment, a user can charge the smartphone 30 only by storing the smartphone 30 in the storage body, such as a pocket. That is, since the smartphone 30 is charged while a user carries the smartphone 30 even in a case where the user frequently uses the smartphone 30, it is possible to suppress the running out of the battery of the smartphone 30.

### Eighth Embodiment

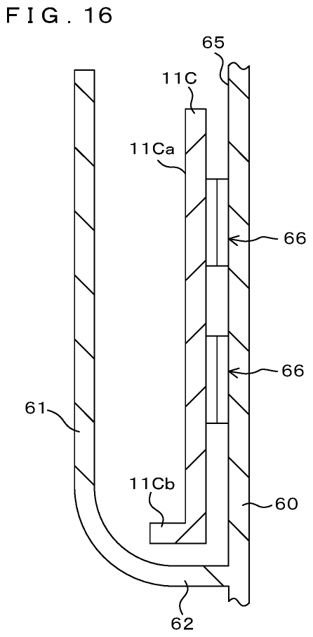

The present invention will be described below with reference to the drawings showing a storage body according to an eighth embodiment. The same components as the components of the first to seventh embodiments among components of the eighth embodiment will be denoted by the same reference numerals as those of the first to seventh embodiments, and the detailed description thereof will be omitted. FIG. 16 is a schematic right side cross-sectional view of the storage body. The storage body according to the eighth embodiment is, for example, a pocket of a garment or a bag.

As in the seventh embodiment, the storage body according to the eighth embodiment includes a support part 60, a facing part 61, and a bottom part 62. A chamber surrounded by a rear surface of the facing part 61, a front surface of the support part 60, and an upper surface of the bottom part 62 forms a storage chamber. A wireless charger 11C including a rechargeable battery, a power transmission unit, a magnetic body, and an adapter (all of them are not shown) is provided on the front surface of the support part 60.

The wireless charger 11C includes a front surface and a rear surface. The front surface forms a charging surface 11Ca. A protruding portion 11Cb protruding forward is formed at a lower edge portion of the charging surface 11Ca. For this reason, the wireless charger 11C has an L shape in a side view. The protruding portion 11Cb is provided with the magnetic body. The rear surface of the wireless charger 11C faces the front surface of the support part 60. An attachment/detachment tool 66 is attached between the rear surface of the wireless charger 11C and the front surface of the support part 60.

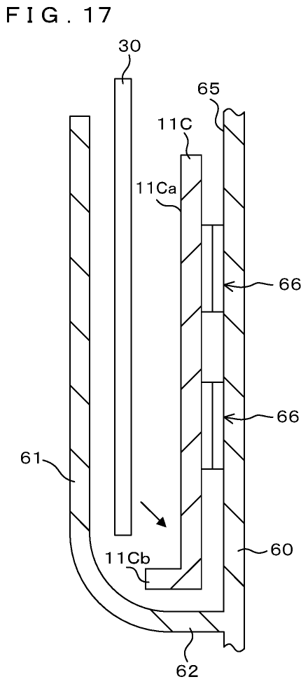

FIG. 17 is a schematic right side cross-sectional view of the storage body in a case where a smartphone 30 is stored in the storage chamber. The smartphone 30 includes a front surface and a rear surface, and a screen is disposed on the front surface. A magnet (not shown) is provided at a lower end portion of the smartphone 30. In a case where the smartphone 30 is stored in the storage chamber so that the lower end portion of the smartphone 30 is disposed above the protruding portion 11Cb, the magnet of the smartphone 30 and the protruding portion 11Cb of the wireless charger 11C are attracted to each other as shown by an arrow of FIG. 17. Accordingly, the smartphone 30 is positioned at a position where the smartphone 30 can be charged on the charging surface 11Ca. Since the lower end portion of the smartphone 30 is in contact with the protruding portion 11Cb, the smartphone 30 is easily and reliably positioned with respect to the wireless charger 11C in the up-down direction.

In the storage body according to the eighth embodiment, a user can charge the smartphone 30 only by storing the smartphone 30 in the storage body, such as a pocket. That is, since the smartphone 30 is charged while a user carries the smartphone 30 even in a case where the user frequently uses the smartphone 30, it is possible to suppress the running out of the battery of the smartphone 30.

### Ninth Embodiment

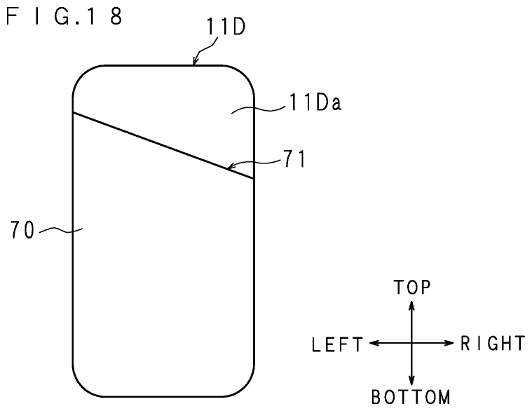

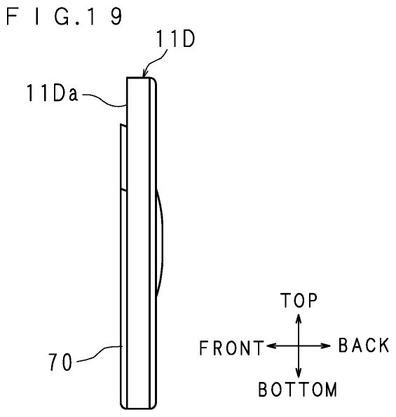

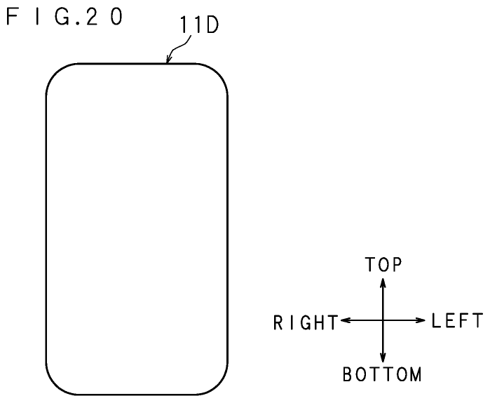

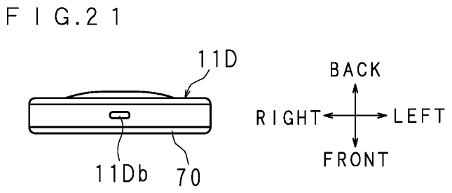

The present invention will be described below with reference to the drawings showing a storage body according to a ninth embodiment. The same components as the components of the first to eighth embodiments among components of the ninth embodiment will be denoted by the same reference numerals as those of the first to eighth embodiments, and the detailed description thereof will be omitted. FIG. 18 is a schematic front view of the storage body, FIG. 19 is a schematic right side view of the storage body, FIG. 20 is a schematic back view of the storage body, and FIG. 21 is a schematic bottom view of the storage body.

The storage body includes a wireless charger 11D having the shape of a rectangular plate. The wireless charger 11D extends in the up-down direction. One surface of the wireless charger 11D orients the front, and the other surface thereof orients the back. The wireless charger 11D includes a power transmission unit and a rechargeable battery (all of them are not shown). One surface of the wireless charger 11D, that is, the front surface forms a charging surface 11Da. In a case where a portable terminal is placed on the charging surface 11Da, the portable terminal is charged with a magnetic field generated from the power transmission unit. An adapter 11Db is provided on the bottom surface of the wireless charger 11D. The wireless charger 11D can charge the rechargeable battery through the adapter 11Db.

A facing part 70 facing the charging surface 11Da is provided on the front side of the wireless charger 11D. The facing part 70 is made of, for example, fabric having stretchability or elasticity. Meanwhile, the fabric may not have stretchability or elasticity. The dimension of the facing part 70 in the up-down direction is smaller than the dimension of the wireless charger 11D in the up-down direction. A right edge portion, a left edge portion, and a lower edge portion of the facing part 70 are connected to a right edge portion, a left edge portion, and a lower edge portion of the charging surface 11Da, respectively. An upper edge portion of the facing part 70 is inclined to descend toward the right side without being connected to the charging surface 11Da. The upper edge portion of the facing part 70 may not be inclined, and may be formed, for example, at a right angle to the left and right edge portions or may be formed in a curve. The charging surface 11Da is exposed above the upper edge portion of the facing part 70. A pocket of which the upper side is open is formed by the facing part 70 and the charging surface 11Da, and a storage chamber 71 in which a portable terminal is to be stored is formed between the facing part 70 and the charging surface 11Da.

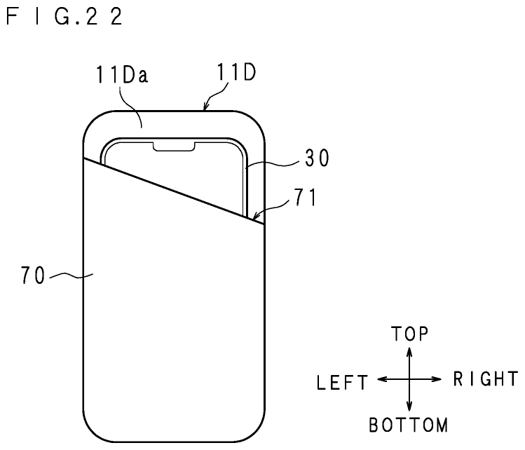

FIG. 22 is a schematic front view of the storage body in which a smartphone 30 is stored in the storage chamber 71. The dimension of the facing part 70 in the left-right direction is slightly larger than that of the smartphone 30. For this reason, the smartphone 30 stored in the storage chamber 71 is positioned in the left-right direction by the right edge portion and the left edge portion of the facing part 70. The maximum value of the dimension of the facing part 70 in the up-down direction is slightly smaller than the dimension of the smartphone 30 in the up-down direction. In a case where the smartphone 30 is inserted into the storage chamber 71 up to the bottom of the storage chamber 71, the smartphone 30 stored in the storage chamber 71 is positioned in the up-down direction.

Since the smartphone 30 is positioned in the left-right direction and the up-down direction, the position of a coil provided in the smartphone 30 and the position of a coil of the power transmission unit can be aligned with each other. In a case where the smartphone 30 is stored in the storage chamber 71, the wireless charger 11D detects the smartphone 30 and charges the smartphone 30.

Designs may be applied to the surfaces of the storage body. For example, after designs according to the user's order are applied to the surfaces of the storage body, the storage body may be provided to a user.

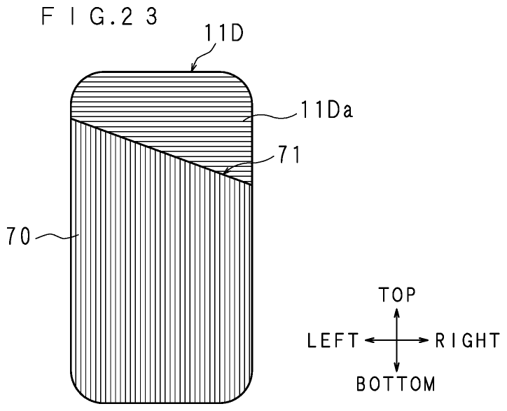

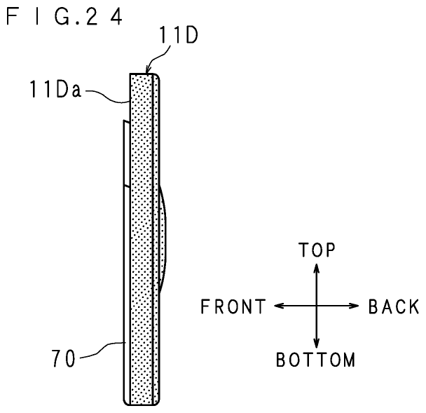

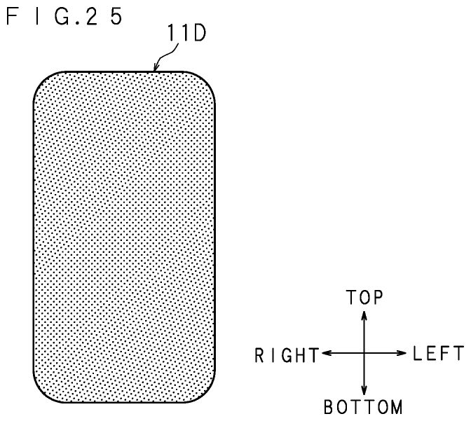

FIG. 23 is a schematic front view of the storage body having designs on the surfaces thereof, FIG. 24 is a schematic right side view of the storage body having designs on the surfaces thereof, and FIG. 25 is a schematic back view of the storage body having designs on the surfaces thereof. As shown in FIGS. 23 to 25, patterns are applied to the front surface of the facing part 70 and the charging surface 11Da and a color different from the colors of the facing part 70 and the charging surface 11Da is applied to the back surface and the side surfaces of the wireless charger 11D. The same color or the same pattern may be applied to the back surface and the side surfaces of the wireless charger 11D, the charging surface 11Da, and the facing part 70.

In a case where a storage body is to be manufactured, for example, an interface for receiving an order receives the design of the storage body from a user. A user can have access to the interface via the Internet or the like. A plurality of designs are prepared in the interface in advance, and a user can select any one of the designs. A manufacturer applies the design received from the interface to a storage body, manufactures the storage body, and ships the storage body to the user. A design can be applied to the facing part or the charging surface 11Da, the back surface, or the side surfaces of the wireless charger 11D. A design includes patterns and colors.

In the storage body according to the ninth embodiment, a user can charge the smartphone 30 only by storing the smartphone 30 in the storage body. That is, since the smartphone 30 is charged while a user carries the smartphone 30 in a state where the storage body in which the smartphone 30 is stored is put in a bag or the like even in a case where the user frequently uses the smartphone 30, it is possible to suppress the running out of the battery of the smartphone 30.

It is to be noted that, as used herein and in the appended claims, the singular forms “a”, “an”, and “the” include plural referents unless the context clearly dictates otherwise.

The embodiments disclosed this time should be considered to be exemplary in all respects and not restrictive. The technical features described in the respective embodiments can be combined with each other and the scope of the present invention is intended to include all modifications within claims and a scope equivalent to claims.

1-16. (canceled)

17. A storage body, comprising:
a first storage chamber in which a wireless charger is stored;
a second storage chamber which is adjacent to the first storage chamber and in which a portable terminal to be charged by the wireless charger is to be stored; and
an attachment/detachment tool that attaches the first storage chamber and the second storage chamber to an object and detaches the first storage chamber and the second storage chamber from the object.

18. The storage body according to claim 17, further comprising:
a guide that is disposed in the second storage chamber and positions the portable terminal at a power receiving position where the portable terminal is capable of receiving power to be supplied from the wireless charger.

19. The storage body according to claim 17, wherein the second storage chamber is formed by a member having stretchability.

20. The storage body according to claim 17, wherein the attachment/detachment tool includes a belt, a string, a magnet, a hook-and-loop fastener, a button, or a clip.

21. The storage body according to claim 17, wherein an opening causing the first storage chamber to communicate with an outside is formed in the first storage chamber.

22. The storage body according to claim 21, further comprising:
an opening/closing unit that opens and closes the opening.

23. A storage body, comprising:
a first storage chamber in which a wireless charger is stored;
a second storage chamber which is adjacent to the first storage chamber and in which a portable terminal to be charged by the wireless charger is to be stored; and
a positioning tool that positions the portable terminal at a position where the portable terminal is capable of being charged on the wireless charger.

24. The storage body according to claim 23, wherein the first storage chamber and the second storage chamber form a pocket of a garment or a bag.

25. A storage body, comprising:
a storage chamber in which a wireless charger for charging a portable terminal is stored;
an attachment/detachment tool that attaches the wireless charger to the storage chamber and detaches the wireless charger from the storage chamber; and
a positioning tool that positions the portable terminal at a position where the portable terminal is capable of being charged on the wireless charger.

26. The storage body according to claim 25, wherein the wireless charger includes a charging surface facing the portable terminal, and
the positioning tool includes a recessed portion that is formed on the charging surface, and a protruding portion that is provided on the portable terminal and is fitted into the recessed portion.

27. The storage body according to claim 25, wherein the wireless charger includes a charging surface facing the portable terminal, and
the positioning tool includes a protruding portion formed on the charging surface.

28. The storage body according to claim 25, wherein the storage chamber forms a pocket of a garment or a bag.

29. A storage body, comprising:
a wireless charger that includes a charging surface;
a facing part that faces the charging surface; and
a storage chamber which is formed between the charging surface and the facing part and in which a portable terminal to be charged by the wireless charger is to be stored.

30. A method of manufacturing a storage body, comprising:
receiving a selection of a design for a storage body including a wireless charger that includes a charging surface, a facing part that faces the charging surface, and a storage chamber which is formed between the charging surface and the facing part and in which a portable terminal to be charged by the wireless charger is to be stored; and
applying the received design to the facing part or the wireless charger.

31. A garment, comprising:
a garment body;
a first storage chamber which is formed on the garment body and in which a wireless charger is stored to be capable of being taken out;
a second storage chamber which is adjacent to the first storage chamber and in which a portable terminal to be charged by the wireless charger is to be stored; and
the wireless charger that is stored in the first storage chamber and charges the portable terminal in a state where the portable terminal stored in the second storage chamber is positioned at a position where the portable terminal is capable of being charged by a magnetic force.

32. A method of attaching a wireless charger, comprising:
providing an attachment/detachment tool on at least one of a storage chamber and a wireless charger; and
detachably attaching the wireless charger to the storage chamber through the attachment/detachment tool.
